(19) United States
(12) Patent Application Publication
(10) Pub. No.: US 2026/0261305 A1
(43) Pub. Date: Sep. 3, 2026

(54) LOW COMPLEXITY MACHINE LEARNING-BASED CHANNEL STATE INFORMATION COMPRESSION

(71) Applicant: Google LLC, Mountain View, CA (US)

(72) Inventors: Yushu Zhang, Beijing (CN); Chih-Hsiang Wu, Taipei City (TW)

(21) Appl. No.: 18/994,553

(22) PCT Filed: May 25, 2023
(86) PCT No.: PCT/CN2023/096258

§ 371 Date: Jan. 14, 2025

(30) Foreign Application Priority Data
Aug. 12, 2022 (WO) PCT/CN2022/112193

(51) Int. Cl. H04B 7/06; H04B 7/0456; H04W 72/21

(52) U.S. Cl. CPC H04B 7/0626; H04B 7/0456; H04W 72/21

(57) ABSTRACT

This disclosure provides systems, devices, apparatus, and methods, including computer programs encoded on storage media, for low-complexity ML-based CSI compression (270a). A UE (102) receives (240), from a network entity (104), a CSI-RS for a channel estimation (250). The UE (102) sends (285), to the network entity (104), a CSI report including a first PMI and a second PMI. The first PMI indicates a wideband preceder (355) associated with the channel estimation (250) and the second PMI indicates a compressed subband eigenvecter associated with the wideband preceder (355).

### CROSS REFERENCE TO RELATED APPLICATION(S)

This application claims the benefit of and priority to International Application No. PCT/CN2022/112193, entitled “CSI Reports based on ML Techniques” and filed on Aug. 12, 2022, which is expressly incorporated by reference herein in its entirety.

### TECHNICAL FIELD

The present disclosure relates generally to wireless communication, and more particularly, to channel state information (CSI) reports based on machine learning (ML) techniques.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, user equipments (UEs) and base stations can support more antenna configurations and multi-connectivity. One consequence, however, is that channel state information (CSI) reports have become larger and more complex.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

Machine learning (ML) models may be used to perform channel state information (CSI) compression. For example, a user equipment (UE) may receive a channel state information-reference signal (CSI-RS) from a network entity, such as a base station, that the UE measures for estimating a channel associated with the CSI-RS. The UE can calculate Eigenvectors for the channel in each subband, such that the Eigenvectors can be input to the ML model to output compressed Eigenvectors for a CSI report transmitted to the network entity. In examples, a first v columns of an Eigenvector for an average channel associated with each subband may be used as the input for CSI compression. The UE reports the compressed CSI to the network entity in the CSI report, which decodes the CSI report to determine the compressed Eigenvectors, and then subsequently decompress the compressed Eigenvectors to reconstruct the non-compressed Eigenvectors that the UE calculated for the channel in each subband.

Calculation of the first v Eigenvectors may be performed based on singular vector decomposition (SVD) techniques for the average channel associated with each subband. However, calculating an increased number of Eigenvectors for compressing into the CSI report may result in increased complexity at the UE. That is, performing Eigenvector calculations for each subband may be computationally heavy in some examples, which may cause increased overhead at the UE. As a number of transmission ports for the CSI-RS increases, SVD complexity also increases.

Aspects of the present disclosure address the above-noted and other deficiencies by implementing techniques that reduce UE complexity for ML-based CSI compression by reducing complexities associated with the Eigenvector calculations. For example, the UE can select a wideband precoder for calculation of the Eigenvectors and input the Eigenvectors associated with the wideband precoder into the ML model for CSI compression. Compression of the Eigenvectors based on a wideband precoder reduces overhead/complexity at the UE in comparison to calculating/compressing the Eigenvectors for each subband.

According to some aspects, the UE receives, from a network entity, a CSI-RS for a channel estimation. The UE sends, to the network entity, a CSI report including a first precoding matrix indicator (PMI) and a second PMI. The first PMI indicates the wideband precoder associated with the channel estimation and the second PMI that indicates a compressed subband eigenvector associated with the wideband precoder.

According to some aspects, the network entity transmits, to the UE, the CSI-RS to produce a channel estimation from a CSI report. The network entity receives, from the UE, the CSI report including the first PMI and the second PMI. The first PMI indicates the wideband precoder associated with the channel estimation and the second PMI indicates the compressed subband eigenvector associated with the wideband precoder.

### BRIEF DESCRIPTION OF THE DRAWINGS

FIG. 1 illustrates a diagram of a wireless communications system including a plurality of user equipments (UEs) and network entities in communication over one or more cells.

FIG. 2 illustrates a diagram for example machine learning (ML)-based channel state information (CSI) encoder compression at a UE and example ML-based CSI decoder decompression at a network entity.

FIG. 3 illustrates an example of a diagram for low complexity ML-based CSI compression.

FIG. 4 is a signaling diagram that illustrates an example of a low complexity ML-based CSI reporting procedure.

FIG. 5 is a flowchart of an example method of wireless communication at a UE for CSI compression and reporting.

FIG. 6 is a flowchart of an example method of wireless communication at a network entity for CSI decompression of a low complexity CSI report.

FIGS. 7A-7D illustrate tables of examples ML-based CSI reports.

FIG. 8 is a diagram illustrating an example of a hardware implementation for an example UE apparatus.

FIG. 9 is a diagram illustrating an example of a hardware implementation for one or more example network entities.

### DETAILED DESCRIPTION

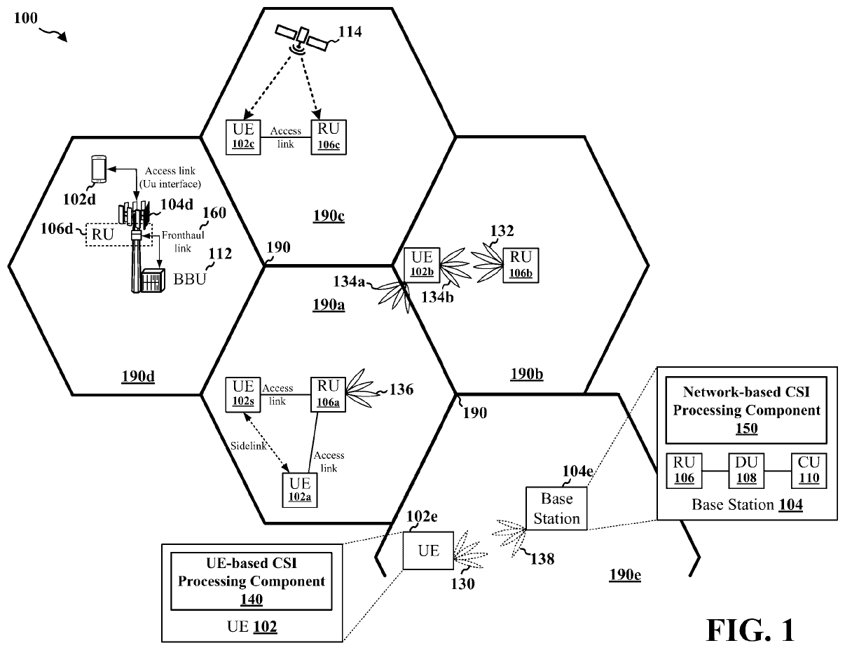

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHZ). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 may or may not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, the UE 102 may include a UE-based channel state information (CSI) processing component 140 configured to receive, from a network entity, a channel state information-reference signal (CSI-RS) for channel estimation; and send, to the network entity, a CSI report including a first precoding matrix indicator (PMI) and a second PMI, the first PMI indicating a wideband precoder associated with the channel estimation, and the second PMI indicating a compressed subband eigenvector associated with the wideband precoder.

In certain aspects, the base station 104 or a network entity of the base station 104 may include a network-based CSI processing component 150 configured to transmit, to a UE, a CSI-RS to produce a channel estimation from a CSI report; and receive, from the UE, the CSI report including a first PMI and a second PMI, the first PMI indicating a wideband precoder associated with the channel estimation and the second PMI indicating a compressed subband eigenvector associated with the wideband precoder. Although the following description may be focused on 5G NR, the concepts described herein may be applicable to other similar areas, such as 5G-Advanced and future versions, LTE, LTE-advanced (LTE-A), and other wireless technologies, such as 6G.

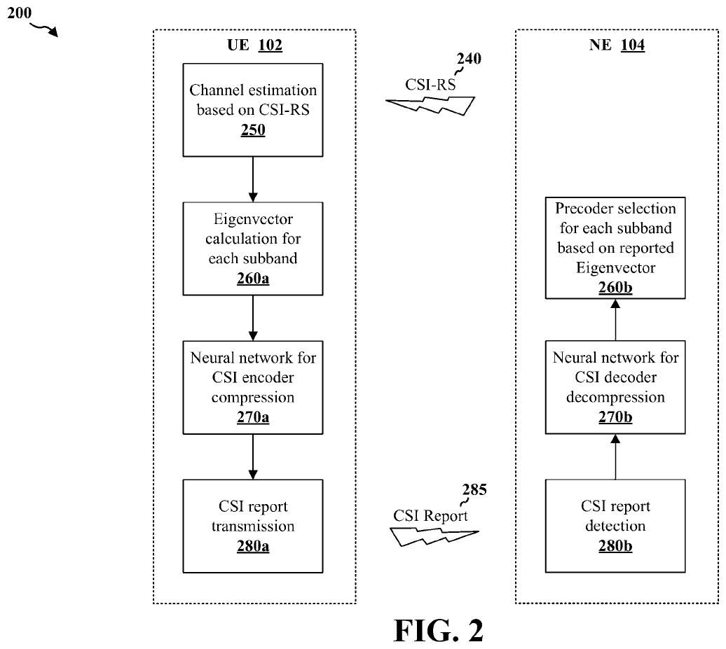

FIG. 2 illustrates a diagram 200 for example machine learning (ML)-based CSI encoder compression at a UE 102 and example ML-based CSI decoder decompression at a network entity 104. In a MIMO system, the network entity 104 may use CSI to select a digital precoder for a UE 102. The network entity 104 may configure a CSI report 285 through RRC signaling (e.g., CSI-reportConfig), where the UE 102 uses a channel measurement resource (CMR) to measure a CSI-RS 240 for estimating 250 a downlink channel. The network entity 104 may also configure (e.g., via the CSI-reportConfig), an interference measurement resource (IMR) for the UE 102 to measure interference. Based on the CMR and the IMR, the UE 102 is able to identify the CSI, which may include a rank indicator (RI), a precoding matrix indicator (PMI), a channel quality indicator (CQI), and/or a layer indicator (LI). The RI and the PMI are used to determine a digital precoder (also called a precoding matrix), the CQI indicates a signal-to-interference plus noise (SINR) for determining the transmitter's selection of a modulation and coding scheme (MCS). The LI is used to identify a strongest layer, such as for multi-user (MU)-MIMO pairing with low rank transmissions and the precoder selection for a phase-tracking reference signal (PT-RS).

The UE 102 may indicate the CSI report 285 in two parts via physical uplink control channel (PUCCH)/physical uplink shared channel (PUSCH), where CSI part 1 may include the RI and the CQI for a first transport block (TB), and CSI part 2 may include the PMI, the LI, and the CQI for a second TB. A payload size for CSI part 2 may be based on the CSI part 1, and both parts may be transmitted to the network entity 104 with separate channel coding operations.

The network entity 104 may configure a time-domain behavior (e.g., periodic, semi-persistent, or aperiodic report) for the CSI report 285 in the CSI-reportConfig. The network entity 104 can activate or deactivate a semi-persistent CSI report through a MAC control element (MAC CE). The network entity 104 can also trigger an aperiodic CSI report through downlink control information (DCI). The UE 102 may report the periodic CSI on a PUCCH resource configured in the CSI-reportConfig. The UE 102 may report the semi-persistent CSI on a PUCCH resource configured in the CSI-reportConfig or a PUSCH resource triggered by the DCI from the network entity 104. The UE 102 may report the aperiodic CSI on a PUSCH resource triggered by the DCI from the network entity 104.

In resource element k for a CSI-RS 240, the received signal in frequency domain may be obtained as follows:

$${Y}_{k} = {H}_{k} {X}_{k} + {N}_{k}$$

where Hₖ indicates the effective channel including an analog beamforming weight with a dimension of N_{Rx} by N_{Tx}, Xₖ indicates the CSI-RS 240 at resource element k, Nₖ indicates the interference plus noise, N_{Rx} indicates a number of receiving ports, and N_{Tx} indicates a number of transmission ports.

In resource element k for a physical downlink shared channel (PDSCH), the received signal in frequency domain may correspond to:

$${Y}_{k} = {H}_{k} {W}_{k} {X}_{k} + {N}_{k}$$

where Wₖ indicates the precoder. Usually for subcarriers within a subband (e.g., a bundled physical resource block (PRB)), the precoder is the same.

The UE 102 may use a Type 2 CSI codebook to measure and report the CSI, where the precoder is quantized based on:

$$W = {W}_{1} {W}_{2}$$

where W₁ corresponds to a wideband precoder with dimensions of N_{Tx} by 2L; W₂ corresponds to a subband precoder with dimensions of 2L by v; L corresponds to a number of beams; and v corresponds to a number of layers, which may be RI+1.

W₁ may be quantized based on a codebook, while W₂ may be quantized based on a power and an angle for each element, which may result in a large overhead since W₂ is subband-based, and there may be multiple subbands for the CSI report 285, which may be determined based on a bandwidth for the CSI-RS 240. In examples, the codebook for W₁ selection may correspond to:

$${W}_{1} = [ \begin{matrix}B & 0 \\ 0 & B\end{matrix} ]$$

$$B = [ \begin{matrix}{b}_{1} & {b}_{2} & … & {b}_{L} ]\end{matrix}$$

$${b}_{l} = {u}_{m} ⊗ {v}_{n}$$

$${u}_{m} = [ \begin{matrix}1 & {e}^{\frac{j 2 π m}{{N}_{1} {O}_{1}}} & … & {{e}^{\frac{j 2 π ( {N}_{1} - 1 ) m}{{N}_{1} {O}_{1}}} ]}^{T}\end{matrix}$$

$${v}_{n} = [ \begin{matrix}1 & {e}^{\frac{j 2 π n}{{N}_{2} {O}_{2}}} & … & {{e}^{\frac{j 2 π ( {N}_{2} - 1 ) n}{{N}_{2} {O}_{2}}} ]}^{T}\end{matrix}$$

where, ⊗ denotes a Kronecker product; L indicates the number of beams configured by RRC signaling; N₁, N₂, O₁, and O₂ correspond to the number of ports and an oversampling factor in a horizontal and vertical domain, which may be configured via the RRC signaling. Candidate values may be based on the number of CSI-RS ports. The codebook includes precoders with different values of m and n. In examples, the candidate values are based on predefined protocols.

ML is an example technique that the UE 102 may implement for performing the CSI compression 270a, where a first v columns of an Eigenvector for an average channel for each subband may be used as input. As used herein, unless otherwise specifically indicated, the terms “machine learning” and “artificial intelligence” may be used interchangeably with each other.

The diagram 200 illustrates an example for ML-based CSI compression after the UE 102 receives the CSI-RS 240 from the network entity 104. The UE 102 may perform channel estimation 250 based on the CSI-RS 240, and calculate 260a the Eigenvector for the channel in each subband. The Eigenvectors may be input to a neural network for CSI encoder compression 270a. The UE 102 transmits 280a the compressed CSI report 285 to the network entity 104.

The network entity 104 performs CSI report detection 280b of the CSI report transmission 280a from the UE 102. A neural network at the network entity 104 decodes the compressed CSI report 285 to recover the Eigenvector via CSI decoder decompression 270b. The network entity 104 selects 260b a precoder for each subband based on the reported Eigenvector.

For each subband, the Eigenvector V may be derived based on singular vector decomposition (SVD) of the average channel in the subband as follows:

$${USV}^{H} = \frac{1}{N} {\sum }_{k ∈ S} {\hat{H}}_{k}$$

where N indicates the number of CSI-RS resource elements for the subband S; Ĥₖ indicates the estimated channel based on the CSI-RS 240 at resource element k.

ML-based CSI compression techniques may refer to the following terminology:

Data collection refers to a process of collecting data by the network nodes, the management entity, or the UE 102 for ML model training, data analytics, and inference.

ML model refers to a data-driven algorithm that applies ML techniques to generate a set of outputs based on a set of inputs.

ML model training refers to a process of training the ML model (e.g., by learning the input/output relationship) in a data-driven manner to obtain the trained ML model for inference.

ML model inference refers to a process of using the trained ML model to generate a set of outputs based on a set of inputs.

ML model validation refers to a sub-process of ML model training for evaluating a quality of the ML model using a dataset different from a training dataset used for model training. The different data may be used for selecting model parameters that generalize the data beyond the dataset used for the ML model training.

ML model testing refers to a sub-process of ML model training for evaluating the performance of the trained ML model using the dataset that is different from the training dataset for the ML model training and validation. Different from ML model validation, testing does not assume subsequent tuning of the ML model.

UE-side ML model refers to an ML model where inferencing is performed at the UE 102.

Network-side ML model refers to an ML model where inferencing is performed at the network/network entity 104.

One-sided ML model refers to a UE-side ML model or a network-side ML model.

Two-sided ML model refers to a paired ML model(s) over which joint inference is performed, where joint inference includes an ML inference that is performed jointly across the UE 102 and the network entity 104 (e.g., a first portion of inference is performed by the UE 102 and a remaining portion of the inference is performed by the network entity 104, or vice versa).

ML model transfer refers to delivery of an ML model over an air interface, based on either parameters of a model structure known at the receiving end or a new model with parameters. Delivery techniques may include transfer of a full ML model or a ML partial model.

Model download refers to ML model transfer from the network entity 104 to the UE 102.

Model upload refers to ML model transfer from the UE 102 to the network entity 104.

Federated learning/federated training refers to a machine learning technique that trains an ML model across multiple decentralized edge nodes (e.g., UEs, network entities, etc.) that each perform local model training using local data samples. Federated learning/training may be based on multiple interactions with the ML model, but without exchanging local data samples.

Offline field data refers to the data collected from the field and used for offline training of the ML model.

Online field data refers to the data collected from the field and used for online training of the ML model.

Model monitoring refers to a procedure for monitoring the inference performance of the ML model.

Supervised learning refers to a process of training a model from inputs and corresponding labels.

Unsupervised learning refers to a process of training a model without labelled data.

Semi-supervised learning refers to a process of training a model based on a mix of labelled data and unlabelled data.

Reinforcement learning (RL) refers to a process of training an ML model from input (or state) and a feedback signal (or reward) resulting from the model's output (or action) in an environment with which the model interacts.

Model activation refers to enabling an ML model for a specific function.

Model deactivation refers to disabling an ML model for a specific function.

Model switching refers to deactivating a currently active ML model and activating a different ML model for a specific function.

Complexities at the UE resulting from Eigenvector calculations may be associated with increased processing capabilities at the UE. For each subband, the calculation of the first Eigenvector V₁ may be based on singular vector decomposition (SVD) of the average channel, which may correspond to:

$${USV}_{1}^{H} = \frac{1}{N} {\sum }_{k ∈ S} {\hat{H}}_{k}$$

where N indicates the number of CSI-RS resource elements for subband S and Ĥₖ corresponds to the estimated channel based on CSI-RS at resource element k. A number of transmission ports for the CSI-RS may be large in some examples (e.g., N_{Tx}=32). Thus, the complexity for the SVD may be high. Hence, a method is proposed to reduce UE complexity for ML-based CSI compression, including Eigenvector calculation complexity reduction.

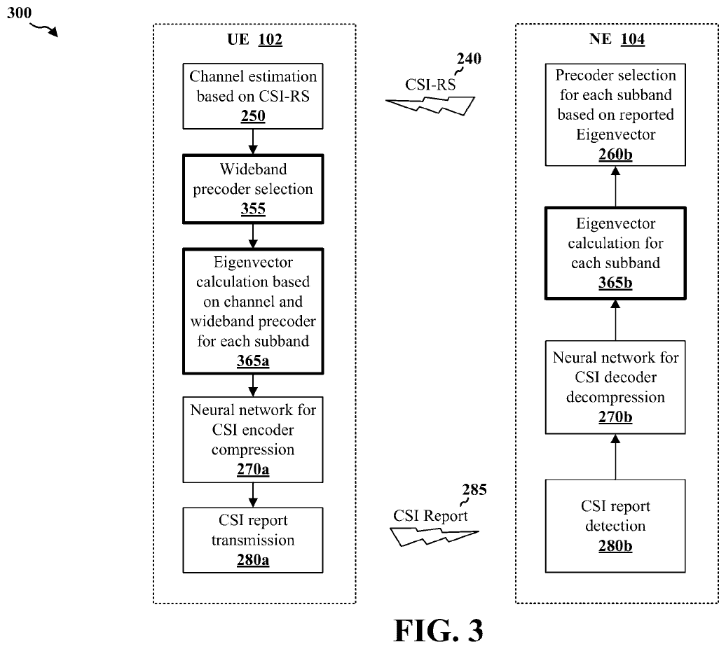

FIG. 3 illustrates a diagram 300 for low complexity ML-based CSI compression. Elements 240, 250, 260b, 270a-270b, 280a-280b, and 285 have already been described with respect to FIG. 2.

After the UE 102 estimates 250 the channel based on the received CSI-RS 240, the UE 102 may select 355 a wideband precoder W₁ for the CSI compression. In examples, the codebook for the wideband precoder W₁ selection 355 may be based on:

$${W}_{1} = [ \begin{matrix}B & 0 \\ 0 & B\end{matrix} ]$$

$$B = [ \begin{matrix}{b}_{1} & {b}_{2} & … & {b}_{L} ]\end{matrix}$$

$${b}_{l} = {u}_{m} ⊗ {v}_{n}$$

$${u}_{m} = [ \begin{matrix}1 & {e}^{\frac{j 2 π m}{{N}_{1} {O}_{1}}} & … & {{e}^{\frac{j 2 π ( {N}_{1} - 1 ) m}{{N}_{1} {O}_{1}}} ]}^{T}\end{matrix}$$

$${v}_{n} = [ \begin{matrix}1 & {e}^{\frac{j 2 π n}{{N}_{2} {O}_{2}}} & … & {{e}^{\frac{j 2 π ( {N}_{2} - 1 ) n}{{N}_{2} {O}_{2}}} ]}^{T}\end{matrix}$$

where, ⊗ indicates a Kronecker product; L indicates a number of beams configured by RRC signaling; N₁, N₂, O₁, and O₂ correspond to a number of ports and an oversampling factor in a horizontal and a vertical domain, which may be configured by RRC signaling. Candidate values for the codebook may be based on a number of CSI-RS ports. The codebook may include precoders with different values of m and n.

The UE 102 performs an Eigenvector calculation 365a based on the channel estimation and the wideband precoder for each subband. The dimension of

$$\frac{1}{N} {\sum }_{k ∈ S} {\hat{H}}_{k} {W}_{1}$$

may correspond to N_{Rx} by 2L, where L is configured by RRC parameter. In an example, L may be equal to 2, such that the dimensions of the input matrix for SVD may be much smaller than the input to the neural network in the diagram 200. For example, in the diagram 300, the input to the neural network for the CSI encoder compression 270a may be determined based on:

$${USV}_{2}^{H} = \frac{1}{N} {\sum }_{k ∈ S} {\hat{H}}_{k} {W}_{1}$$

The first v columns of a second Eigenvector V₂ may be the input of the neural network, where v indicates a number of layers. W₁ corresponds to the wideband precoder, which may be quantized based on a predefined codebook or a codebook configured by the network entity 104 (e.g., a Type1 or Type2 codebook). After a neural network for CSI decoder decompression 270b at the network entity 104 decompresses the compressed CSI encoder, the network entity 104 performs a similar Eigenvector calculation 365b for each subband, as performed 365a at the UE 102, to determine the precoder selection 260b for each subband based on the reported Eigenvector.

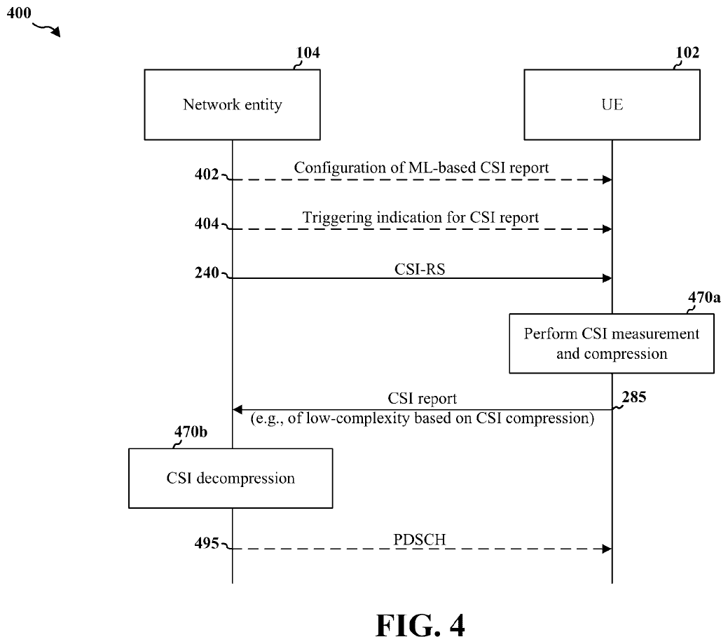

FIG. 4 is a signaling diagram 400 that illustrates a low complexity ML-based CSI reporting procedure. The network entity 104 transmits 402, to the UE 102 based on RRC signaling, a configuration (e.g., CSI-reportConfig) for an ML-based CSI report. The CSI report may be ML-based when a codebookType in the CSI-reportConfig is set to a first particular value (e.g., ‘ai-Ml’ or ‘type3’) or a reportQuantity in the CSI-reportConfig is set as a second particular value (e.g., ‘ri-compressedPmi-cqi’). The network entity 104 may also transmit 402 a configuration for a non-ML-based CSI report, which may be based on a particular codebook (e.g., Type1 or Type2 codebook).

The network entity 104 may transmit 404, to the UE 102, a triggering indication for triggering the CSI report from the UE 102. However, for periodic CSI reports, transmission 404 of the triggering indication may be skipped by the network entity 104, as the UE 102 may report periodic CSI reports via uplink resources configured 402 by the RRC signaling from the network entity 104. The triggering indication for semi-persistent and aperiodic CSI reporting may be a MAC-CE or DCI. For example, the network entity 104 may transmit 404 a MAC-CE to activate a semi-persistent CSI report. In other examples, the network entity 104 may transmit 404 DCI to trigger an aperiodic CSI report.

The UE 102 receives 240, from the network entity 104, CSI-RS associated with the triggered or configured CSI report. The UE 102 may perform 470a CSI measurement and compression based on reception 240 of the CSI-RS. For example, the UE 102 may compress the CSI based on low complexity techniques for ML-based compression, as illustrated in the diagram 300, where compared to the diagram 200 (e.g., the first Eigenvector (Eigenvector V₁) being used as the input to the ML model), the second Eigenvector (Eigenvector V₂) is used as the input to the ML model.

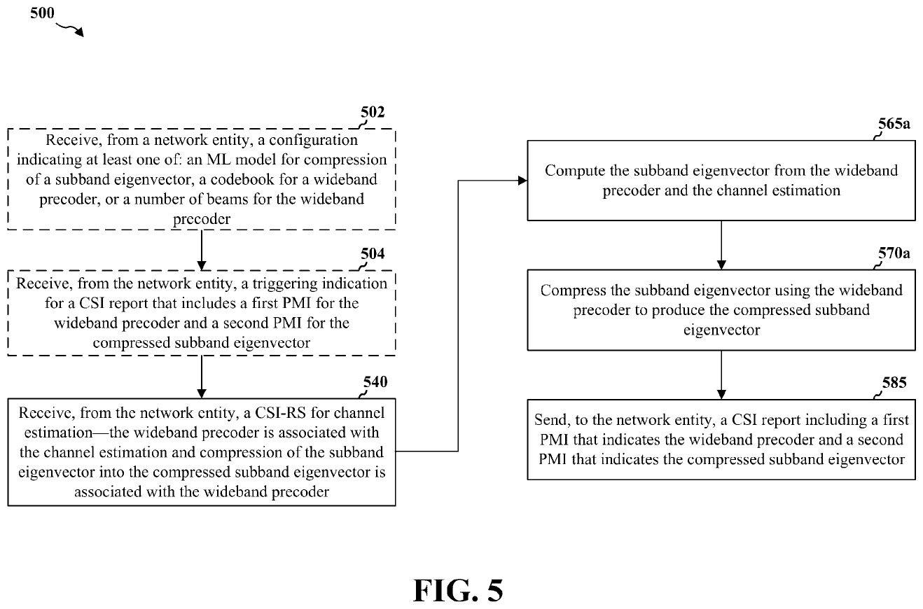

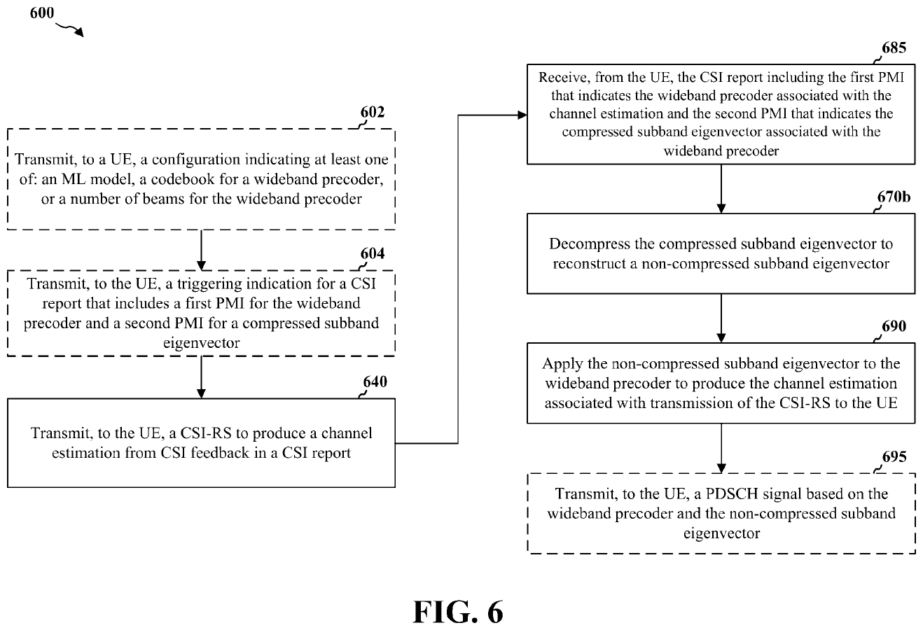

After the UE 102 performs 470a the CSI measurement and compression, the UE 102 may transmit 285 the compressed CSI to network entity 104. That is, the UE 102 may transmit 285 a low complexity CSI report to the network entity 104 based on the CSI compression. The network entity 104 receives 285 the low complexity CSI report from the UE 102 and decompress 470b the CSI based on the ML model. The network entity 104 can transmit 495 a PDSCH to the UE 102 based on the CSI decompression 470b (e.g., based on the wideband precoder and the non-compressed/reconstructed subband eigenvectors). FIGS. 5-6 show methods for implementing one or more aspects of FIGS. 2-4. In particular, FIG. 5 shows an implementation by the UE 102 of the one or more aspects of FIGS. 2-4. FIG. 6 shows an implementation by the network entity 104 of the one or more aspects of FIGS. 2-4.

FIG. 5 illustrates a flowchart 500 of a method of wireless communication at a UE. With reference to FIGS. 1-4 and 8, the method may be performed by the UE 102, the UE apparatus 802, etc., which may include the memory 826′, 806′, 816, and which may correspond to the entire UE 102 or the entire UE apparatus 802, or a component of the UE 102 or the UE apparatus 802, such as the wireless baseband processor 826 and/or the application processor 806.

The UE 102 receives 502, from a network entity, a configuration indicating at least one of: an ML model for compression of a subband eigenvector, a codebook for a wideband precoder, or a number of beams for the wideband precoder. For example, referring to FIG. 4, the UE 102 receives 402, from the network entity 104, a configuration for the ML-based CSI report.

The UE 102 receives 504, from the network entity, a triggering indication for a CSI report that includes a first PMI for the wideband precoder and a second PMI for the compressed subband eigenvector. For example, referring to FIG. 4, the UE 102 receives 404, from the network entity 104, a triggering indication for the CSI report.

The UE 102 receives 540, from the network entity, a CSI-RS for channel estimation—the wideband precoder is associated with the channel estimation and compression of the subband eigenvector into the compressed subband eigenvector is associated with the wideband precoder. For example, referring to FIGS. 2-4, the UE 102 receives 240, from the network entity 104, a CSI-RS for estimating 250 the channel to then select 355 the wideband precoder, compute 365a the subband eigenvector, and compress 270a the subband eigenvector using the wideband precoder.

The UE 102 computes 565a the subband eigenvector from the wideband precoder and the channel estimation. For example, referring to FIG. 3, the UE 102 calculates 365a the eigenvector based on the channel and the wideband precoder for each subband.

The UE 102 compresses 570a the subband eigenvector using the wideband precoder to produce the compressed subband eigenvector. For example, referring to FIGS. 2-4, the UE 102 performs 270a/470a CSI encoder compression using a neural network.

The UE 102 sends 585, to the network entity, a CSI report including a first PMI that indicates the wideband precoder and a second PMI that indicates the compressed subband eigenvector. For example, referring to FIGS. 2-4, the UE 102 sends 285, to the network entity 104, a CSI report.

The input to the neural network for CSI encoder compression 270a at the UE 102 may be based on the selected wideband precoder 355 and the estimated channel 250 from the CSI-RS 240. In examples, the input may be the first v columns of the second Eigenvector V2 calculated based on the SVD of matrix

$$\frac{1}{N} {\sum }_{k ∈ S} {\hat{H}}_{k} {W}_{1} .$$

The number of beams for W₁ as well as the searched codebook may be configured 402 based on higher layer signaling (e.g. RRC signaling). The codebook may correspond to a Type1 or Type2 CSI codebook. In an example, the codebook for precoder W₁ selection 355 may be based on:

$${W}_{1} = [ \begin{matrix}B & 0 \\ 0 & B\end{matrix} ]$$

$$B = [ \begin{matrix}{b}_{1} & {b}_{2} & … & {b}_{L} ]\end{matrix}$$

$${b}_{l} = {u}_{m} ⊗ {v}_{n}$$

$${u}_{m} = [ \begin{matrix}1 & {e}^{\frac{j 2 π m}{{N}_{1} {O}_{1}}} & … & {{e}^{\frac{j 2 π ( {N}_{1} - 1 ) m}{{N}_{1} {O}_{1}}} ]}^{T}\end{matrix}$$

$${v}_{n} = [ \begin{matrix}1 & {e}^{\frac{j 2 π n}{{N}_{2} {O}_{2}}} & … & {{e}^{\frac{j 2 π ( {N}_{2} - 1 ) n}{{N}_{2} {O}_{2}}} ]}^{T}\end{matrix}$$

where, ⊗ indicates a Kronecker product; L indicates a number of beams, which may be configured by RRC signaling (e.g., numberOfBeams); N₁, N₂, O₁, and O₂ correspond to a number of ports and an oversampling factor in a horizontal and a vertical domain, which may be configured by RRC signaling (e.g., n1-n2). Candidate values for the codebook may be based on a number of CSI-RS ports. The codebook may include precoders with different value of m and n.

FIG. 6 is a flowchart 600 of a method of wireless communication at a network entity. With reference to FIGS. 1-4 and 9, the method may be performed by one or more network entities 104, which may correspond to a base station or a unit of the base station, such as the RU 106, the DU 108, the CU 110, an RU processor 906, a DU processor 926, a CU processor 946, etc. The one or more network entities 104 may include memory 906′/926′/946′, which may correspond to an entirety of the one or more network entities 104, or a component of the one or more network entities 104, such as the RU processor 906, the DU processor 926, or the CU processor 946.

The network entity 104 transmits 602, to a UE, a configuration indicating at least one of: an ML model, a codebook for a wideband precoder, or a number of beams for the wideband precoder. For example, referring to FIG. 4, the network entity 104 transmits 402, to the UE 102, a configuration for the ML-based CSI report.

The network entity 104 transmits 604, to the UE, a triggering indication for a CSI report that includes a first PMI for the wideband precoder and a second PMI for a compressed subband eigenvector. For example, referring to FIG. 4, the network entity 104 transmits 404, to the UE 102, a triggering indication for the CSI report.

The network entity 104 transmits 640, to the UE, a CSI-RS to produce a channel estimation from CSI feedback in a CSI report. For example, referring to FIGS. 2-4, the network entity 104 transmits 240, to the UE 102, a CSI-RS for estimating the channel based on CSI feedback in a CSI report 285.

The network entity 104 receives 685, from the UE, the CSI report including the first PMI that indicates the wideband precoder associated with the channel estimation and the second PMI that indicates the compressed subband eigenvector associated with the wideband precoder. For example, referring to FIGS. 2-4, the network entity 104 receives 285, from the UE 102, the CSI report based on the low complexity techniques for CSI compression.

The network entity 104 decompresses 670b the compressed subband eigenvector to reconstruct a non-compressed subband eigenvector. For example, referring to FIGS. 2-4, the network entity 104 performs 270b/470b CSI decoder decompression using a neural network.

The network entity 104 applies 690 the non-compressed subband eigenvector to the wideband precoder to produce the channel estimation associated with transmission of the CSI-RS to the UE. For example, referring to FIGS. 2-3, the network entity 104 selects 260b a precoder for each subband based on the reported Eigenvector for estimating the channel.

The network entity 104 transmits 695, to the UE, a PDSCH signal based on the wideband precoder and the non-compressed subband eigenvector. For example, referring to FIG. 4, the network entity 104 transmits 495, to the UE 102, a PDSCH based on the CSI decompression 470b.

ML model(s) for CSI encoder compression 270a may be configured 402 by higher layer signaling from the network entity 104 (e.g., RRC signaling) or predefined/preconfigured. Different ML models may be used for different codebooks. For example, a first ML model may be used for a codebook with a certain number of configured beams and a second ML model may be used for a codebook with a configured number of beams, N₁, N₂, O₁, and O₂. ML models may also be used for codebooks with a certain number of subbands, number of configured beams, N₁, N₂, O₁, and O₂, etc.

The RRC configuration of the codebook for the ML-based CSI report may be based on a UE capability reported to the network entity 104 by the UE 102 for codebooks associated with ML-based CSI reports. For an ML-based CSI report, a first precoder matrix index (PMI) for W₁ may be reported 285 by the UE 102 as well as an output of the ML model for the CSI encoder compression 270a, which may be indicated based on a compressed Eigenvector. In further examples, the UE 102 may report a second PMI for each subband to the network entity 104. In examples, the first PMI may be reported as two indexes, including a first index used to indicate the horizontal beam index m and a second index used to indicate the vertical beam index n. The second PMI may correspond to the output of the ML model used for the CSI encoder compression 270a.

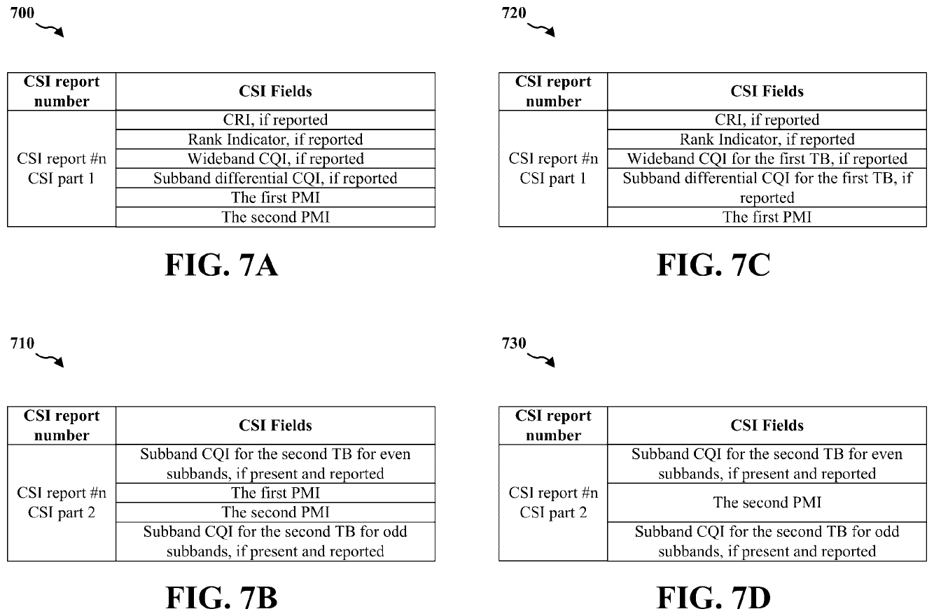

FIGS. 7A-7D illustrate tables 700-730 of example ML-based CSI reports. The tables 700-730 include a CSI report number field that indicates a CSI report #n as well as a CSI part (e.g., CSI part 1 or CSI part 2) associated with the ML-based CSI report. The network entity uses CSI part 1 to decode CSI part 2, which carries the channel estimation information. The tables 700-730 also include CSI fields that indicate information associated with a CSI-RS resource indicator (CRI), RI, wideband CQI, subband (differential) CQI, PMI(s), etc.

For short PUCCH-based CSI reports, both PMIs and other CSI may be reported in a single CSI part (e.g., CSI part 1). Table 700 of FIG. 7A illustrates an example ML-based CSI report format associated with a short PUCCH.

For PUSCH or long PUCCH-based CSI reports, both PMIs may be reported in CSI part 2, where a bit-width for CSI part 2 is based on information reported in CSI part 1 (e.g., CRI/RI and CQI for a first transport block (TB)). Table 710 of FIG. 7B illustrates an example ML-based CSI report format with CSI part 2 in long PUCCH and PUSCH.

For PUSCH or long PUCCH-based CSI reports, both PMIs may be reported in CSI part 2, or the first PMI may be reported in CSI part 1 and the second PMI may be reported in CSI part 2. Table 720 of FIG. 7C and Table 730 of FIG. 7D illustrate examples of ML-based CSI report formats with CSI part 1 and CSI part 2 in long PUCCH and PUSCH.

Low complexity CSI compression may be enabled by RRC signaling from the network entity 104 (e.g., an RRC parameter in the CSI-reportConfig), which may be based on the UE capability report. A codebook may have a codebookType configured as ‘ML’ or ‘Type3’. The RRC signaling for an ML codebook may include at least one of: a number of beams (L), a number of ports in a horizontal and a vertical domain (N₁, N₂), a number of oversampling factors in the horizontal and the vertical domain (O₁, O₂), a number of subbands for CSI compression, a number of subbands per CQI calculation, which indicates the number of subbands for CSI compression used for the CQI calculation, an RI constraint, which may be used to indicate the candidate ranks for precoder selection, or an ML model, which indicates the ML model used for the CSI compression. Subtypes of the low complexity ML-based CSI compression may be indicated in the codebook configuration to indicate whether the ML-based CSI report is a low complexity ML-based CSI report (e.g., typeIII-hybrid or other ML-based report).

Unless otherwise specified herein, RRC signaling may indicate an RRC reconfiguration message from the network entity 104 to the UE 102, or a system information block (SIB), where the SIB may be a predefined SIB (e.g., SIB1) or a different SIB transmitted by the network entity 104. The network entity 104 may obtain the UE capability via UE capability report signaling or from the UE 102, another network entity/base station, or a core network entity, such as an AMF.

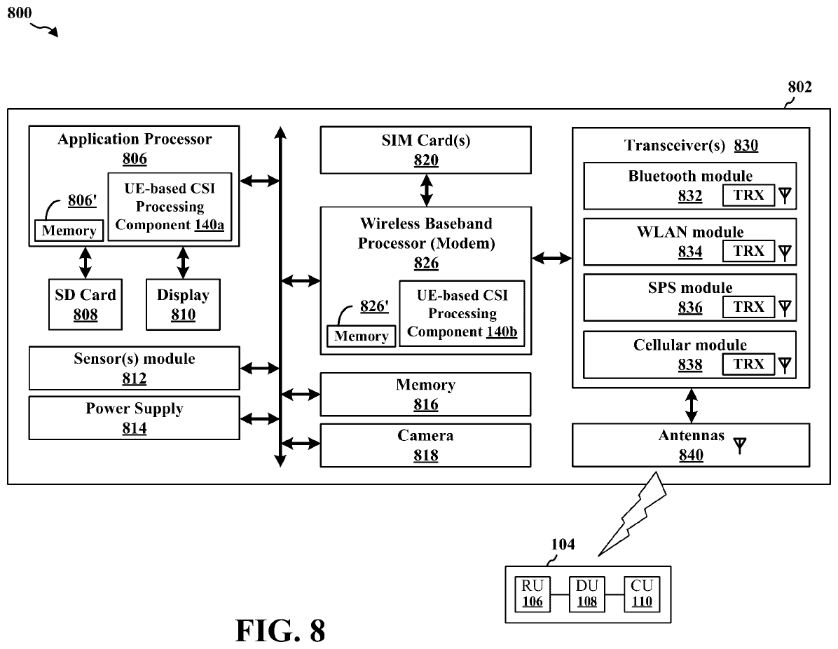

FIG. 8 is a diagram 800 illustrating an example of a hardware implementation for a UE apparatus 802. The UE apparatus 802 may be the UE 102, a component of the UE 102, or may implement UE functionality. The UE apparatus 802 may include an application processor 806, which may have on-chip memory 806′. In examples, the application processor 806 may be coupled to a secure digital (SD) card 808 and/or a display 810. The application processor 806 may also be coupled to a sensor(s) module 812, a power supply 814, an additional module of memory 816, a camera 818, and/or other related components. For example, the sensor(s) module 812 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 802 may further include a wireless baseband processor 826, which may be referred to as a modem. The wireless baseband processor 826 may have on-chip memory 826′. Along with, and similar to, the application processor 806, the wireless baseband processor 826 may also be coupled to the sensor(s) module 812, the power supply 814, the additional module of memory 816, the camera 818, and/or other related components. The wireless baseband processor 826 may be additionally coupled to one or more subscriber identity module (SIM) card(s) 820 and/or one or more transceivers 830 (e.g., wireless RF transceivers).

Within the one or more transceivers 830, the UE apparatus 802 may include a Bluetooth module 832, a WLAN module 834, an SPS module 836 (e.g., GNSS module), and/or a cellular module 838. The Bluetooth module 832, the WLAN module 834, the SPS module 836, and the cellular module 838 may each include an on-chip transceiver (TRX), or in some cases, just a transmitter (TX) or just a receiver (RX). The Bluetooth module 832, the WLAN module 834, the SPS module 836, and the cellular module 838 may each include dedicated antennas and/or utilize antennas 840 for communication with one or more other nodes. For example, the UE apparatus 802 can communicate through the transceiver(s) 830 via the antennas 840 with another UE (e.g., sidelink communication) and/or with a network entity 104 (e.g., uplink/downlink communication), where the network entity 104 may correspond to a base station or a unit of the base station, such as the RU 106, the DU 108, or the CU 10.

The wireless baseband processor 826 and the application processor 806 may each include a computer-readable medium/memory 826′, 806′, respectively. The additional module of memory 816 may also be considered a computer-readable medium/memory. Each computer-readable medium/memory 826′, 806′, 816 may be non-transitory. The wireless baseband processor 826 and the application processor 806 may each be responsible for general processing, including execution of software stored on the computer-readable medium/memory 826′, 806′, 816. The software, when executed by the wireless baseband processor 826/application processor 806, causes the wireless baseband processor 826/application processor 806 to perform the various functions described herein. The computer-readable medium/memory may also be used for storing data that is manipulated by the wireless baseband processor 826/application processor 806 when executing the software. The wireless baseband processor 826/application processor 806 may be a component of the UE 102. The UE apparatus 802 may be a processor chip (e.g., modem and/or application) and include just the wireless baseband processor 826 and/or the application processor 806. In other examples, the UE apparatus 802 may be the entire UE 102 and include the additional modules of the apparatus 802.

As discussed in FIG. 1 and implemented with respect to FIG. 5, the UE-based CSI processing component 140 is configured to receive, from a network entity, a CSI-RS for channel estimation; and send, to the network entity, a CSI report including a first PMI and a second PMI, the first PMI indicating a wideband precoder associated with the channel estimation, and the second PMI indicating a compressed subband eigenvector associated with the wideband precoder. The UE-based CSI processing component 140 may be within the application processor 806 (e.g., at 140a), the wireless baseband processor 826 (e.g., at 140b), or both the application processor 806 and the wireless baseband processor 826. The UE-based CSI processing component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

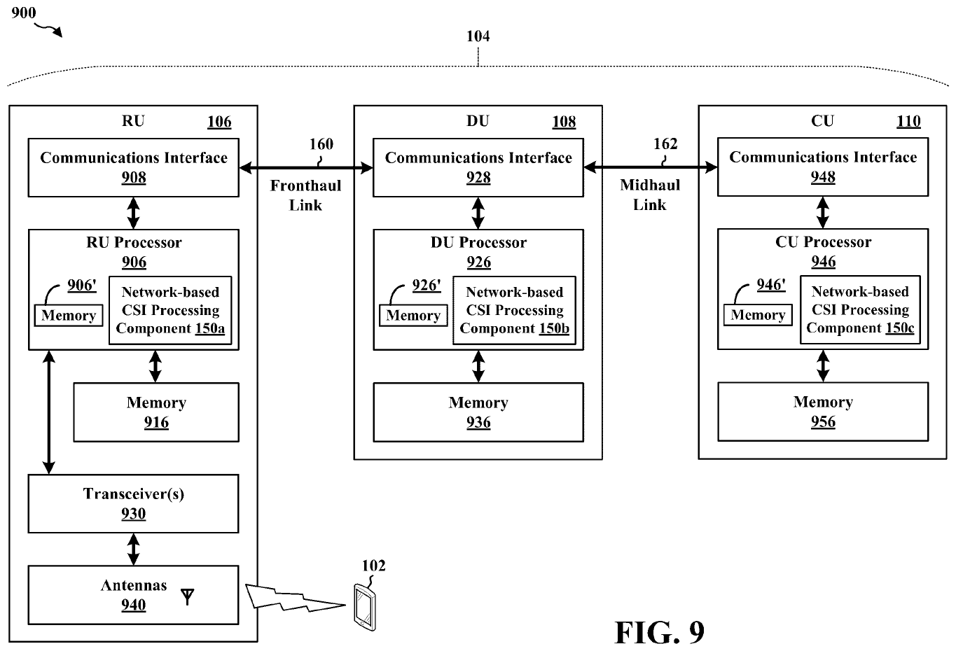

FIG. 9 is a diagram 900 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 946, which may have on-chip memory 946′. In some aspects, the CU 110 may further include an additional module of memory 956 and/or a communications interface 948, both of which may be coupled to the CU processor 946. The CU 110 can communicate with the DU 108 through a midhaul link 162, such as an F1 interface between the communications interface 948 of the CU 110 and a communications interface 928 of the DU 108.

The DU 108 may include a DU processor 926, which may have on-chip memory 926′. In some aspects, the DU 108 may further include an additional module of memory 936 and/or the communications interface 928, both of which may be coupled to the DU processor 926. The DU 108 can communicate with the RU 106 through a fronthaul link 160 between the communications interface 928 of the DU 108 and a communications interface 908 of the RU 106.

The RU 106 may include an RU processor 906, which may have on-chip memory 906′. In some aspects, the RU 106 may further include an additional module of memory 916, the communications interface 908, and one or more transceivers 930, all of which may be coupled to the RU processor 906. The RU 106 may further include antennas 940, which may be coupled to the one or more transceivers 930, such that the RU 106 can communicate through the one or more transceivers 930 via the antennas 940 with the UE 102.

The on-chip memory 906′, 926′, 946′ and the additional modules of memory 916, 936, 956 may each be considered a computer-readable medium/memory. Each computer-readable medium/memory may be non-transitory. Each of the processors 906, 926, 946 is responsible for general processing, including execution of software stored on the computer-readable medium/memory. The software, when executed by the corresponding processor(s) 906, 926, 946 causes the processor(s) 906, 926, 946 to perform the various functions described herein. The computer-readable medium/memory may also be used for storing data that is manipulated by the processor(s) 906, 926, 946 when executing the software. In examples, the network-based CSI processing component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 6, the network-based CSI processing component 150 is configured to transmit, to a UE, a CSI-RS to produce a channel estimation from a CSI report; and receive, from the UE, the CSI report including a first PMI and a second PMI, the first PMI indicating a wideband precoder associated with the channel estimation, and the second PMI indicating a compressed subband eigenvector associated with the wideband precoder. The network-based CSI processing component 150 may be within one or more processors of the one or more network entities 104, such as the RU processor 906 (e.g., at 150a), the DU processor 926 (e.g., at 150b), and/or the CU processor 946 (e.g., at 150c). The network-based CSI processing component 150a-150c may be one or more hardware components specifically configured to carry out the stated processes/algorithm, implemented by one or more processors 906, 926, 946 configured to perform the stated processes/algorithm, stored within a computer-readable medium for implementation by the one or more processors 906, 926, 946, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a CSI-RS for channel estimation; and sending, to the network entity, a CSI report including a first PMI and a second PMI, the first PMI indicating a wideband precoder associated with the channel estimation and the second PMI indicating a compressed subband eigenvector associated with the wideband precoder.

Example 2 may be combined with Example 1 and further includes computing a subband eigenvector from the wideband precoder and the channel estimation.

Example 3 may be combined with any of Examples 1-2 and further includes compressing the subband eigenvector using the wideband precoder to produce the compressed subband eigenvector.

Example 4 may be combined with any of Examples 1-3 and includes that the compression of the subband eigenvector is based on using an ML model to produce the compressed subband eigenvector.

Example 5 may be combined with Example 4 and includes that a predefined protocol indicates the ML model for the compression of the subband eigenvector.

Example 6 may be combined with any of Examples 1~4 and further includes receiving, from the network entity, a configuration indicating at least one of: the ML model for the compression of the subband eigenvector, a codebook for the wideband precoder, or a number of beams for the wideband precoder.

Example 7 may be combined with any of Examples 1-6 and further includes receiving, from the network entity, a triggering indication for the CSI report, the CSI report including the first PMI indicating the wideband precoder and the second PMI indicating the compressed subband eigenvector.

Example 8 may be combined with any of Examples 1-7 and includes that the sending the CSI report, further includes: transmitting, to the network entity, the CSI report using a PUCCH format that includes the first PMI and the second PMI in a same CSI part of the PUCCH format.

Example 9 may be combined with any of Examples 1-7 and includes that the sending the CSI report, further includes: transmitting, to the network entity, the CSI report using a PUCCH format that includes the first PMI and the second PMI in different CSI parts of the PUCCH format.

Example 10 may be combined with any of Examples 1-7 and includes that the sending the CSI report, further includes: transmitting, to the network entity, the CSI report using a PUSCH transmission that includes the first PMI and the second PMI in a same CSI part of the PUSCH transmission.

Example 11 may be combined with any of Examples 1-7 and includes that the sending the CSI report, further includes: transmitting, to the network entity, the CSI report using a PUSCH transmission that includes the first PMI and the second PMI in different CSI parts of the PUSCH transmission.

Example 12 is a method of wireless communication at a network entity, including: transmitting, to a UE, a CSI-RS to produce a channel estimation from a CSI report; and receiving, from the UE, the CSI report including a first PMI and a second PMI, the first PMI indicating a wideband precoder associated with the channel estimation, and the second PMI indicating a compressed subband eigenvector associated with the wideband precoder.

Example 13 may be combined with Example 12 and further includes decompressing the compressed subband eigenvector to reconstruct a non-compressed subband eigenvector.

Example 14 may be combined with any of Examples 12-13 and includes that the decompressing the compressed subband eigenvector is based on using an ML model to reconstruct the non-compressed subband eigenvector.

Example 15 may be combined with Example 14 and includes that a predefined protocol indicates the ML model for the decompressing the compressed subband eigenvector.

Example 16 may be combined with any of Examples 12-14 and further includes transmitting, to the UE, a configuration indicating at least one of: the ML model, a codebook for the wideband precoder, or a number of beams for the wideband precoder.

Example 17 may be combined with any of Examples 12-16 and further includes: transmitting, to the UE, a triggering indication for the CSI report that includes the first PMI for the wideband precoder and the second PMI for the compressed subband eigenvector.

Example 18 may be combined with any of Examples 13-17 and further includes: applying the non-compressed subband eigenvector to the wideband precoder to produce the channel estimation associated with the transmitting the CSI-RS to the UE.

Example 19 may be combined with any of Examples 12-18 and further includes: transmitting, to the UE, a PDSCH signal based on the wideband precoder and the non-compressed subband eigenvector.

Example 20 may be combined with any of Examples 12-19 and includes that the receiving the CSI report, further includes: receiving, from the UE, the CSI report based on a PUCCH format that includes the first PMI and the second PMI in a same CSI part of the PUCCH format.

Example 21 may be combined with any of Examples 12-19 and includes that the receiving the CSI report, further includes: receiving, from the UE, the CSI report based on a PUCCH format that includes the first PMI and the second PMI in different CSI parts of the PUCCH format.

Example 22 may be combined with any of Examples 12-19 and includes that the receiving the CSI report, further includes: receiving, from the UE, the CSI report through a PUSCH transmission that includes the first PMI and the second PMI in a same CSI part of the PUSCH transmission.

Example 23 may be combined with any of Examples 12-19 and includes that the receiving the CSI report, further includes: receiving, from the UE, the CSI report through a PUSCH transmission that includes the first PMI and the second PMI in different CSI parts of the PUSCH transmission.

Example 24 is a method of wireless communication at a UE, including: receiving CSI-RS from a base station; selecting a wideband precoder W₁ based on the CSI-RS; compressing subband eigenvectors, based on the CSI-RS and the wideband precoder W₁; and sending to the base station a first PMI indicating the wideband precoder W₁ and a second PMI, indicating compressed subband eigenvectors.

Example 25 may be combined with example 24 and further includes receiving a RRC message, from the base station, configuring a wideband precoder codebook and the number of beams for the wideband precoder W₁.

Example 26 may be combined with any of examples 24-25 and includes that the RRC message is a RRC reconfiguration message.

Example 27 may be combined with any of examples 24-26 and further includes determining the subband eigenvectors, before the compressing, as the first v columns of eigenvector(s) of

$$\frac{1}{N} {\sum }_{k ∈ S} {\hat{H}}_{k} {W}_{1} ,$$

where N indicates the number of CSI-RS resource elements for subband S; Ĥₖ is the estimated channel based on CSI-RS at resource element k.

Example 28 may be combined with any of examples 24-27 and further includes compressing the subband eigenvectors, based on an AI/ML model.

Example 29 may be combined with any of examples 24-28 and further includes receiving, from the base station, a RRC message for configuring the AI/ML model.

Example 30 may be combined with any of examples 24-29 and includes that the AI/ML model is a predefined AI/ML model or predetermined by the UE.

Example 31 may be combined with any of examples 24-30 and includes that the sending the first PMI and the second PMI further includes: generating a PUCCH transmission using a short PUCCH format and including the first PMI and the second PMI in a single part of the short PUCCH format; and transmitting the PUCCH transmission to the base station.

Example 32 may be combined with any of examples 24-31 and includes that the sending the first PMI and the second PMI further includes generating a PUCCH transmission using a long PUCCH format and including the first PMI and the second PMI in a CSI part 2 of the long PUCCH format; and transmitting the PUCCH transmission to the base station.

Example 33 may be combined with any of examples 24-32 and includes that the sending the first PMI and the second PMI further includes generating a PUCCH transmission using a long PUCCH format and including the first PMI in a CSI part 1 and the second PMI in a CSI part 2 of the long PUCCH format; and transmitting the PUCCH transmission to the base station.

Example 34 may be combined with any of examples 24-33 and includes that the sending the first PMI and the second PMI further includes: generating a PUSCH transmission and including the first PMI and the second PMI in a CSI part 2 of the PUSCH transmission; and transmitting the PUSCH transmission to the base station.

Example 35 may be combined with any of examples 24-34 and includes that the sending the first PMI and the second PMI further includes: generating a PUSCH transmission and including the first PMI in a CSI part 1 and the second PMI in a CSI part 2 of the PUSCH transmission; and transmitting the PUSCH transmission to the base station.

Example 36 is a method of wireless communication at a base station, including: transmitting CSI-RS to a UE; transmitting, to the UE, a first RRC message configuring a wideband precoder codebook and the number of beams for a wideband precoder W₁; receiving from the UE a first precoder matrix indicator (PMI) indicating the wideband precoder W₁ and a second PMI, indicating compressed subband eigenvectors; decompressing the compressed subband eigen vectors to obtain uncompressed subband eigenvectors; and transmitting PDSCH signals using a precoder based on the uncompressed subband eigenvectors.

Example 37 may be combined with example 36 and includes that the precoder is derived based on the uncompressed subband eigenvectors and wideband PMI.

Example 38 may be combined with any of examples 36-37 and further includes decompressing, based on an ML model, the compressed subband eigenvectors to obtain uncompressed subband eigenvectors, based on an ML model.

Example 39 may be combined with any of examples 36-38 and further includes transmitting a second RRC message configuring the AI/ML model to the UE.

Example 40 may be combined with any of examples 36-39 and includes that the AI/ML model is a predefined AI/ML model or is predetermined by the base station.

Example 41 may be combined with any of examples 36-40 and includes that the receiving the first PMI and the second PMI further includes: receiving a PUCCH transmission including the first PMI and the second PMI in accordance with a short PUCCH format.

Example 42 may be combined with any of examples 36-41 and includes that the receiving the first PMI and the second PMI further includes: receiving a PUCCH transmission including the first PMI and the second PMI in CSI part 2 in accordance with a long PUCCH format.

Example 43 may be combined with any of examples 36-42 and includes that the receiving the first PMI and the second PMI further includes receiving a PUCCH transmission including the first PMI in CSI part 1 and the second PMI in CSI part 2 in accordance with a long PUCCH format.

Example 44 may be combined with any of examples 36-43 and includes that the receiving the first PMI and the second PMI further includes receive a PUSCH transmission including the first PMI and the second PMI in CSI part 2.

Example 45 may be combined with any of examples 36-44 and includes that the receiving the first PMI and the second PMI further includes: receiving a PUSCH transmission including the first PMI in CSI part 1 and the second PMI in CSI part 2.

Example 46 is an apparatus for wireless communication for implementing a method as in any of examples 1-45.

Example 47 is an apparatus for wireless communication including means for implementing a method as in any of examples 1-45.

Example 48 is a non-transitory computer-readable medium storing computer executable code, the code when executed by at least one processor causes the at least one processor to implement a method as in any of examples 1-45.

1-18. (canceled)

19. A method of wireless communication at a user equipment (UE), comprising:
receiving, from a network entity, a channel state information-reference signal (CSI-RS) for channel estimation; and
transmitting, to the network entity, a channel state information (CSI) report including a first precoding matrix indicator (PMI) and a second PMI, the first PMI indicating a wideband precoder associated with the channel estimation, and the second PMI indicating a compressed subband eigenvector associated with the wideband precoder.

20. The method of claim 19, further comprising:
computing a subband eigenvector from the wideband precoder and the channel estimation.

21. The method of claim 19, further comprising:
compressing the subband eigenvector using the wideband precoder to produce the compressed subband eigenvector.

22. The method of claim 19, wherein the compression of the subband eigenvector is based on using a machine learning (ML) model to produce the compressed subband eigenvector.

23. The method of claim 22, wherein a predefined protocol indicates the ML model for the compression of the subband eigenvector.

24. The method of claim 19, further comprising:
receiving, from the network entity, a configuration indicating at least one of: the ML model for the compression of the subband eigenvector, a codebook for the wideband precoder, or a number of beams for the wideband precoder.

25. The method of claim 19, further comprising:
receiving, from the network entity, a triggering indication for the CSI report, the CSI report including the first PMI indicating the wideband precoder and the second PMI indicating the compressed subband eigenvector.

26. The method of claim 19, wherein the transmitting the CSI report, further comprises transmitting, to the network entity, the CSI report using at least one of:
a first physical uplink control channel (PUCCH) format that includes the first PMI and the second PMI in a same CSI part of the first PUCCH format,
a second PUCCH format that includes the first PMI and the second PMI in different CSI parts of the second PUCCH format,
a first physical uplink shared channel (PUSCH) transmission that includes the first PMI and the second PMI in a same CSI part of the first PUSCH transmission, or
a second PUSCH transmission that includes the first PMI and the second PMI in different CSI parts of the second PUSCH transmission.

27. A method of wireless communication at a network entity, comprising:
transmitting, to a user equipment (UE), a channel state information-reference signal (CSI-RS) to produce a channel estimation from a channel state information (CSI) report; and
receiving, from the UE, the CSI report including a first precoding matrix indicator (PMI) and a second PMI, the first PMI indicating a wideband precoder associated with the channel estimation, and the second PMI indicating a compressed subband eigenvector associated with the wideband precoder.

28. The method of claim 27, further comprising:
decompressing the compressed subband eigenvector to reconstruct a non-compressed subband eigenvector.

29. The method of claim 28, further comprising:
applying the non-compressed subband eigenvector to the wideband precoder to produce the channel estimation associated with the transmitting the CSI-RS to the UE.

30. The method of claim 27, further comprising:
transmitting, to the UE, a physical downlink shared channel (PDSCH) signal based on the wideband precoder and the non-compressed subband eigenvector.

31. The method of claim 27, wherein the CSI report includes the first PMI and the second PMI in a same CSI part or in different CSI parts.

32. An apparatus for wireless communication at a user equipment (UE), comprising:
a memory;
a transceiver; and
a processor coupled to the memory and the transceiver, the processor being configured to:
receive, from a network entity, a channel state information-reference signal (CSI-RS) for channel estimation; and
transmit, to the network entity, a channel state information (CSI) report including a first precoding matrix indicator (PMI) and a second PMI, the first PMI indicating a wideband precoder associated with the channel estimation, and the second PMI indicating a compressed subband eigenvector associated with the wideband precoder.

33. The apparatus of claim 32, wherein the processor is further configured to:
compute a subband eigenvector from the wideband precoder and the channel estimation.

34. The apparatus of claim 32, wherein the processor is further configured to:
compress the subband eigenvector using the wideband precoder to produce the compressed subband eigenvector.

35. The apparatus of claim 32, wherein the compression of the subband eigenvector is based on using a machine learning (ML) model to produce the compressed subband eigenvector.

36. The apparatus of claim 35, wherein a predefined protocol indicates the ML model for the compression of the subband eigenvector.

37. The apparatus of claim 32, wherein the processor is further configured to:
receive, from the network entity, a configuration indicating at least one of: the ML model for the compression of the subband eigenvector, a codebook for the wideband precoder, or a number of beams for the wideband precoder.

38. The apparatus of claim 32, wherein the processor is further configured to:
receive, from the network entity, a triggering indication for the CSI report, the CSI report including the first PMI indicating the wideband precoder and the second PMI indicating the compressed subband eigenvector.
